(19) United States
(12) Patent Application Publication
(10) Pub. No.: US 2007/0006707 A1
(43) Pub. Date: Jan. 11, 2007

(54) Apparatus for scribing a substrate in use for a flat panel display

(76) Inventors: Young Min Kim, Paju-si (KR); Min Hyung Lee, Daegu (KR)

Correspondence Address: FLESHNER & KIM, LLP, P.O. BOX 221200, CHANTILLY, VA, 20153, US

(21) Appl. No.: 11/482,194

(22) Filed: Jul. 7, 2006

(30) Foreign Application Priority Data
Jul. 8, 2005 (KR) P 2005-0061674

(51) Int. Cl. B26D 3/08; B31B 1/25

(52) U.S. Cl. 83/879

(57) ABSTRACT

There are provided an apparatus for scribing a substrate into discrete substrates in use for a flat panel display, including a supporting plate, a magnetic force generating unit provided to the supporting plate, generating a magnetic force with an electric current supplied from a control unit to produce a linear force along the length of the magnetic force generating unit, an ascending/descending block fixed to the magnetic force generating unit, moving up and down by virtue of the linear force produced by the magnetic force generating unit; a scribing wheel provided to the ascending/descending block, scribing a substrate, and a distance-measuring unit which senses a distance which the ascending/descending block travels and transits information on the traveled distance to the control unit which controls operation of the magnetic force generating unit.

### BACKGROUND OF THE INVENTION

1. Field of the Invention

The present invention relates to an apparatus for scribing a substrate in use for a flat panel display, and more particularly to an apparatus for scribing a substrate into discrete substrates in use for a flat panel display.

2. Description of the Background Art

A substrate-scribing apparatus scribes a substrate, on which patterns are formed, into a plurality of discrete substrates depending on each of sizes of the flat panel display for computer, communication, instrumentation or television. FIG. 1 is a drawing illustrating a conventional substrate-apparatus for scribing the substrate in use for the flat panel display. As shown in FIG. 1, the conventional substrate-apparatus includes an ascending/descending block 1, a scribing wheel holder 2 rotatably provided to the ascending/descending block 1, and a scribing wheel 3 rotatably provided to the scribing wheel holder 2.

The ascending/descending block 1 is provided to a supporting plate (not shown) to be moved up and down. A servomotor and a ball screw are provided to the supporting plate to move the ascending/descending block 1 up and down.

A piston 4, which moves in response to air pressure, is provided to the inside of the ascending/descending block 1 to apply pressure to move the scribing wheel holder 2 down.

A first conductive metal chip is provided to a lower part of the ascending/descending block 1. A second conductive metal chip is provided to one side of the scribing wheel holder 2 in such a manner that the up-and-down movements of the scribing wheel holder 2 enables the second conductive metal chip to be disconnected and connected from and to the second conductive metal chip, respectively. The scribing wheel holder 2 accordingly moves up and thereby the second conductive metal chip 6 is disconnected from the first conductive metal chip 5, when the ascending/descending block 1 moves down and thereby the scribing wheel 3 makes contact with the substrate (not shown). At this point, a control unit, which controls operation of the substrate-scribing apparatus, detects the contact of the scribing wheel 3 with the substrate (not shown).

The air pressure is supplied within the ascending/descending block 1, when the scribing wheel 3 makes contact with the substrate. Thus, the piston 4 moves down to apply pressure to move the scribing wheel holder 3 down. As the supporting plate moves, the scribing wheel 3 begins to scribe the substrate with a predetermined amount of pressure applied to the substrate.

However, the conventional substrate-scribing has the following problems.

The application of too high pressure to the substrate may cause damage to the substrate such as breakage while the scribing wheel scribes the substrate. Conversely, the application of too low pressure to the substrate may prevent the scribing wheel from properly scribing the substrate.

To solve this problem, air pressure is supplied or a bevel gear is used to control the pressure applied to the scribing wheel holder to which the scribing wheel is attached. Thus, the predetermined amount of pressure is continuously applied to the substrate.

The scribing wheel has to be accurately positioned at a specific point on the surface of the substrate before scribing the substrate. Toward this end, in the conventional substrate-scribing apparatus, the position of the scribing wheel on the surface of the substrate is adjusted by controlling the descending movement of the ascending/descending block 1 with the servomotor and thereby detecting the contact of the fist conductive metal chip with the second conductive metal chip which indicates the contact of the scribing wheel 3 with the substrate.

That is, before scribing the substrate, the conventional substrate-scribing apparatus controls the descending movement of the ascending/scribing block 1 to accurately position the scribing wheel on the surface of the substrate, and then controls the pressure applied to the scribing wheel holder by applying air pressure, or using a bevel gear or a cam.

This causes the substrate-scribing apparatus to be complex in its structure and big in its size, thus increasing high maintenance expense.

Furthermore, the conventional method of controlling torque of the servomotor to position the scribing wheel on the surface of the substrate may bring about a discrepancy between the actual and detected positions of the scribing wheel, thus decreasing the accuracy of the position of the scribing wheel on the surface of the susbtrate.

Additionally, the addition of the conductive metal chips to control the position of the scribing wheel requires the complex structure of the substrate-scribing apparatus, thus further decreasing the accuracy of the position of the scribing wheel

### BRIEF DESCRIPTION OF THE INVENTION

Therefore, an object of the present invention is to provide a substrate-scribing apparatus whose a structure is relatively simple, capable of accurately controlling a position of a scribing wheel on a substrate and a load applied to the substrate.

According to an aspect of the present invention, as embodied and broadly described herein, there is provided an apparatus for scribing a substrate in use for a flat panel display, including a supporting plate, a magnetic force generating unit provided to the supporting plate, generating a magnetic force with an electric current supplied from an control unit to produce a linear force along the length of the magnetic force generating unit, an ascending/descending block fixed to the magnetic force generating unit, moving up and down by virtue of the linear force produced by the magnetic force generating unit, and a scribing wheel provided to the ascending/descending block, scribing a substrate.

The magnetic force generating unit may include a voice coil motor which makes it possible to control a position of the scribing wheel on the surface of the substrate and a load applied to the substrate.

The voice coil motor includes a stator which is fixed to the supporting plate and has a permanent magnet attached to the inside of the stator, and a mover which is moved up and down by applying the electric current through a coil of wire formed on the outside surface of the mover and thereby producing a magnetic field opposite to the magnetic field from the permanent magnet attached to the inside of the stator.

The substrate-scribing apparatus may further include a distance-measuring unit which senses a distance which the ascending/descending block travels in a downward or upward direction and transits information on the traveled distance to the control unit which controls operation of the magnetic force generating unit.

The distance-measuring unit may include a linear scale and a linear encoder which serve to sense a relative distance between the ascending/descending block and the supporting plate,

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a drawing illustrating a conventional substrate-apparatus for scribing the substrate in use for a flat panel display;

FIG. 2 is a drawing illustrating a substrate-apparatus for scribing the substrate in use for a flat panel display according to an embodiment of the present invention;

FIG. 3 is a front drawing illustrating the substrate-apparatus for scribing the substrate in use for a flat panel display of FIG. 2;

FIG. 4 is a perspective drawing illustrating the substrate-apparatus for scribing the substrate in use for a flat panel liquid crystal display of FIG. 2; and

FIGS. 5 through 7 are schematic drawings illustrating operation of the substrate-apparatus for scribing the substrate in use for a flat panel display of FIG. 2.

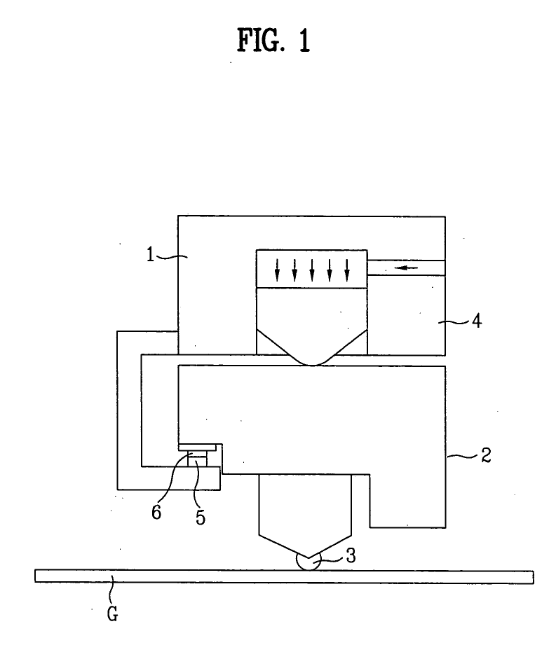

### DETAILED DESCRIPTION OF THE INVENTION

Reference will now be made in detail to the preferred embodiment of the present invention, an example of which is illustrated in the accompanying drawings.

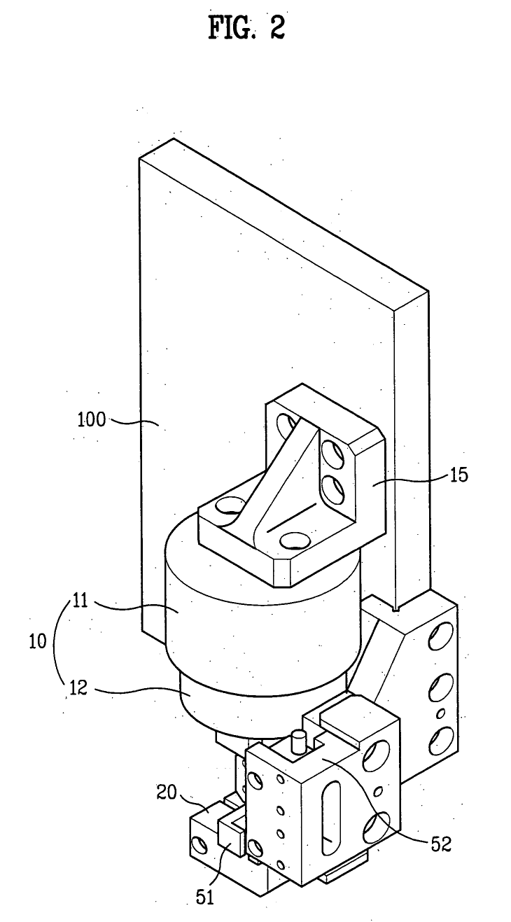

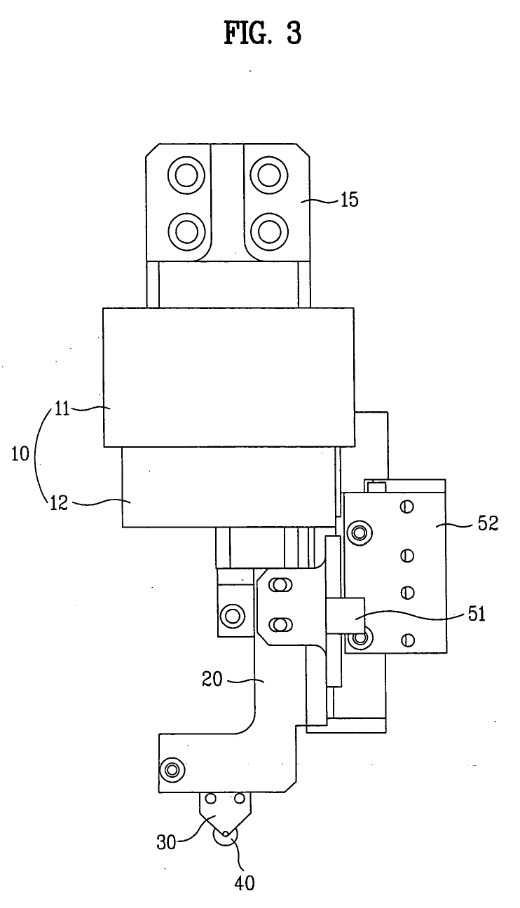

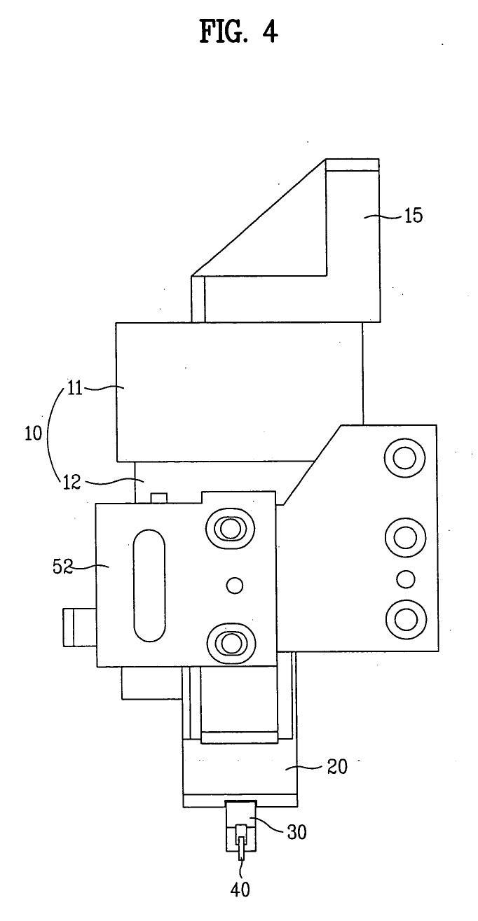

As shown in FIGS. 2 through 4, a substrate-scribing apparatus according to an embodiment of the present invention includes a voice coil motor 10 producing a linear force, an ascending/descending block 20 which is moved up and down by virtue of the linear force produced by the voice coil motor 10, a scribing wheel holder 20 provided to a lower part of the ascending/descending block 20 and a scribing wheel 40 provided to the scribing wheel holder, scribing a substrate.

The voice coil motor 10 is provided to a supporting plate 100 provided over a stage (not shown) on which the substrate is put. The voice coil motor 10 includes a stator 11 fixed to the supporting plate 100 and a mover 12 provided to the inside of the stator 11 to be moved up and down. The stator 11 has a body shaped like a cylinder. An opening is formed on the bottom of the body. A permanent magnet is provided to the inside of the body. A coil of wire (not shown), which reacts to a magnetic field from the permanent magnet, is formed on the outside surface of the mover 12. The magnetic field, which is produced when the electric current is applied to the coil of wire, causes the mover 12 to react to the magnetic field from the permanent magnet. The mover 12 may be elastically supported within the inside of the stator, using an elastic contrivance (now shown) such as a spring. Reference numeral depicts a bracket fixing the voice coil motor 10 to the supporting plate 100.

The pushing force applied to the mover 12 in the voice coil motor 10 varies depending on an amount of the electric current applied to the coil of wire formed on the outside surface of the mover 12. A rapid response is characteristic of the voice coil motor 10.

A linear movement apparatus (not shown) moves the supporting plate 100 in the X and Y directions above the substrate to move the substrate-scribing apparatus at a predetermined position.

The ascending/descending block 20, which is connected to a lower part of the mover 112, is moved up and down depending on the up-and-down movements of the mover 12. The linear scale 51 is fixed to one side of the ascending/descending block 20. The linear encoder is provided to the supporting plate 100 to sense a change in the vertical position of the linear scale 51, which is caused by the up-and-down movements of the ascending/descending block 20.

The linear encoder 52 senses the change in the vertical position of the linear scale 51. i.e., the distance which the linear scale travels in a downward direction and transits information on the traveled distance to the control unit (not shown) controlling the voice coil motor 10.

The substrate-scribing apparatus having the above configuration operates as follows.

First, the scribing wheel 50 is precisely positioned at a predetermined location on the surface of the substrate G. Then, the scribing wheel scribes the substrate with the load applied to the substrate.

Accordingly, it is critical to detect a positional value of the linear scale 51, which is determined at the moment when the scribing wheel 40 accurately makes contact with the surface of the substrate G at the initial phase of scribing the substrate G.

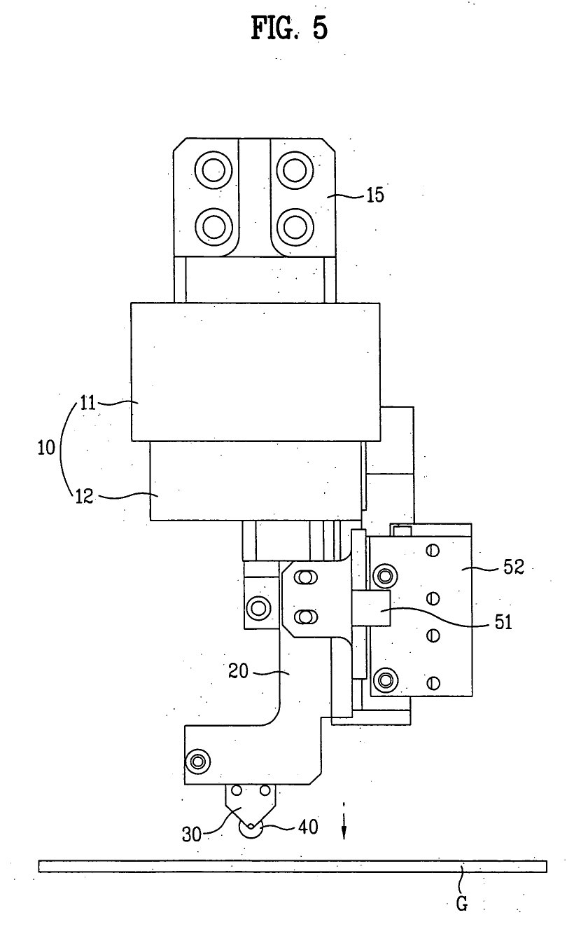

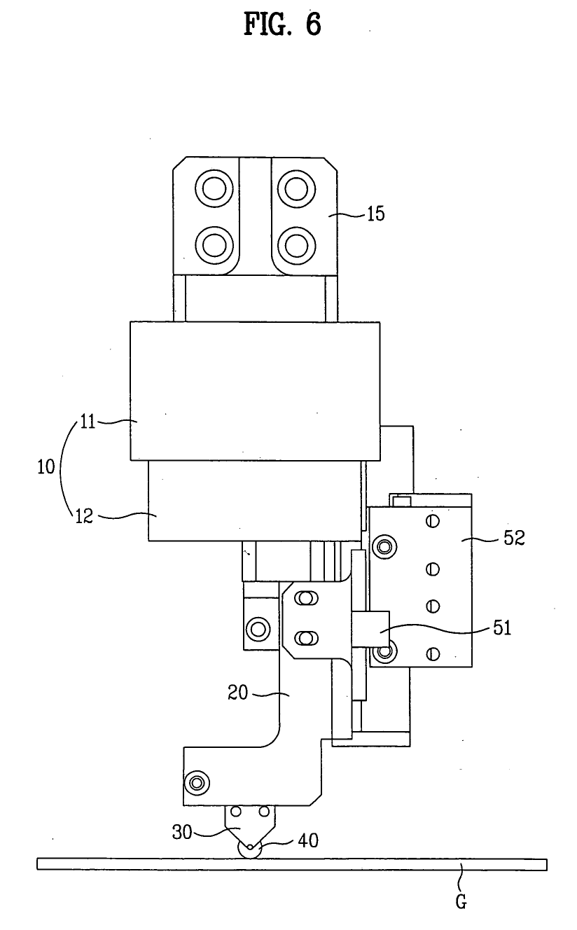

FIGS. 5 and 6 are drawings showing a process to detect the positional value of the linear scale 51. When the substrate-scribing apparatus is in operation, the electric current is applied to the voice coil motor 10 from the control unit (not shown). The application of the electric current generates the magnetic field from the voice coil motor, which causes the mover 12 to react to the magnet field from the permanent magnet, thus slowly moving the mover 12 down.

The ascending/descending block 20 and the scribing wheel move down, as does the mover 12. At this point, the linear encoder 52 senses the distance which the linear scale 51 travels in a downward direction by virtue of the downward movement of the ascending/descending block 20 and transits information on the traveled distance to the control unit in real time.

As shown in FIG.6, when the scribing wheel 40 moves down and makes contact with the surface of the substrate G, the scribing wheel 40 cannot further move down, thus changing a value of the electric current applied to the voice coil motor. At this point, the control unit knows that the scribing wheel 40 makes contact with the substrate G and stores a positional value of the linear scale 51 detected by the linear encoder 52.

Thereafter, the stored positional value is put to reuse as information on the relative position between the scribing wheel and the substrate while the substrate-scribing apparatus scribes the same substrate. That is, the control unit can precisely position the scribing wheel 40 at an arbitrary point on the surface of the same substrate using the existing value of the relative distance between the scribing wheel and the substrate without having to again calculate the relative distance between the scribing wheel and the substrate at the arbitrary point on the surface of the substrate.

As described above, when the scribing wheel 40 makes contact with the surface of the substrate G, the substrate G acts as an obstacle which prevents the scribing wheel 40 from further moving down, thus increasing the value of the electric current.

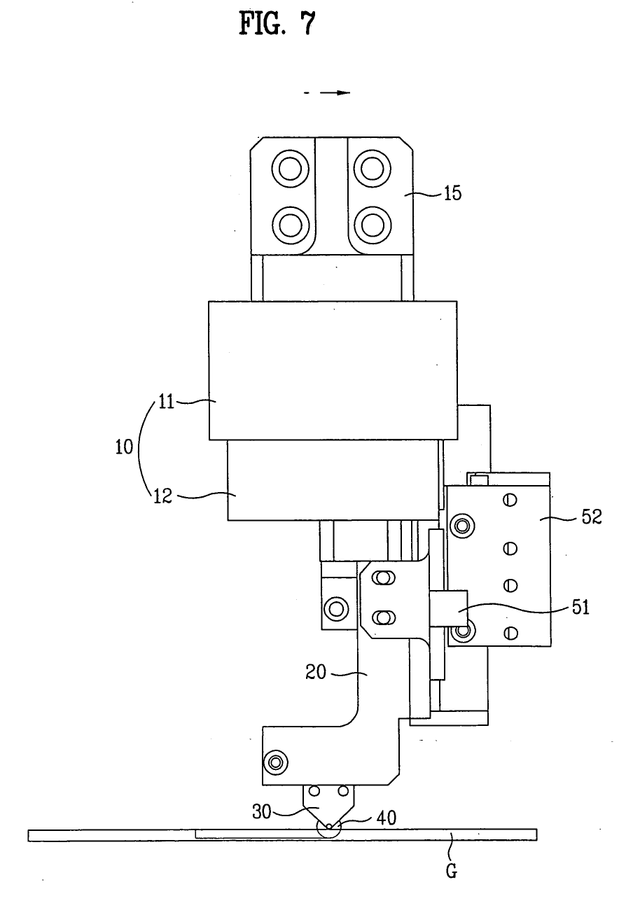

When the value of the electric current reaches the value of the electric current preset in the control unit, the linear movement apparatus moves the supporting plate 100 in the X and Y directions. As shown in FIG. 7, the scribing wheel scribes the surface of the substrate G up to a predetermined depth, resulting in forming a scribe line.

The preset value of the electric current, at which the scribing wheel begins to scribe, varies depending on a thickness of the substrate. For example, the value of the electric current is in proportional to the thickness of the substrate.

Too high pressure of the voice coil motor on the substrate through the scribing wheel 40 may cause damage to the substrate such as breakage. The maximum value of the electric current corresponding to each of the thicknesses of the substrates is preset and stored in the control unit.

The substrate-scribing apparatus controls a position of the scribing wheel with respect to the substrate by providing a predetermined amount of the electric current to the voice coil motor 10 and detecting the change in the amount of the electric current which occurs at the moment when the scribing wheel gets in contract with the substrate. Then, the substrate-scribing apparatus controls the pressure of the scribing wheel on the substrate by gradually increasing a value of the electric current and thereby increasing the load applied to the substrate.

That is, the substrate-scribing apparatus can control the position of the scribing wheel on the surface of the substrate and the load applied to the surface of the substrate, using the voice coil motor 10.

The relative distance between the scribing wheel and the substrate may be obtained by using the information on the change in the positional value of the scribing wheel which is detected by the linear scale 51 and the linear encoder 52, instead of the change in the value of the electric current applied to the voice coil motor.

In addition to the voice coil motor, a variety of kinds of electric motors to produce a linear force along its length may be used to move the ascending/descending block 20 and the scribing wheel 40 up and down.

As is above described, according to the present invention, the control of the position of the scribing wheel on the surface of the substrate and the load applied to the surface of the substrate by the magnetic force generating unit such as the voice coil motor can simplifie configuration and operation of the substrate-scribing apparatus, without having to adding a device to produce a linear movement. Also, the control of the load applied to the surface of the substrate with a gradual change of the electric current applied to the voice coil motor can improve accuracy of scribing the substrate. The position of the scribing wheel on the surface of the substrate can be detected using the linear scale and the linear encoder.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An apparatus for scribing a substrate into discrete substrates in use for a flat panel display, comprising:
a supporting plate;
a magnetic force generating unit provided to the supporting plate, generating a magnetic force with an electric current supplied from a control unit to produce a linear force along the length of the magnetic force generating unit;
an ascending/descending block fixed to the magnetic force generating unit, moving up and down by virtue of the linear force produced by the magnetic force generating unit; and
a scribing wheel provided to the ascending/descending block, scribing a substrate.

2. The apparatus for scribing a substrate into discrete substrates in use for a flat panel display according to claim 1, wherein the magnetic force generating unit is a voice coil motor.

3. The apparatus for scribing a substrate into discrete substrates in use for a flat panel display according to claim 2, wherein the voice coil motor comprises a stator which is fixed to the supporting plate and has a permanent magnet attached to the inside of the stator, and a mover which is moved up and down by applying the electric current through a coil of wire formed on the outside surface of the mover and thereby producing a magnetic field opposite to the magnetic field from the permanent magnet attached to the inside of the stator.

4. The apparatus for scribing a substrate into discrete substrates in use for a flat panel display according to claim 1, further comprising a distance-measuring unit which senses a distance which the ascending/descending block travels and transits information on the traveled distance to the control unit which controls operation of the magnetic force generating unit.

5. The apparatus for scribing a substrate into discrete substrates in use for a flat panel display according to claim 4, wherein the distance-measuring unit comprises a linear scale and a linear encoder which serve to sense a relative distance between the ascending/descending block and the supporting plate,

6. The apparatus for scribing a substrate into discrete substrates in use for a flat panel display according to claim 5, wherein the linear scale and the linear encoder are provided to the ascending/descending block and the supporting plate, respectively in such a manner that the linear encoder senses a distance which the linear scale travels.
